(19) United States
(12) Patent Application Publication
(10) Pub. No.: US 2015/0230042 A1
(43) Pub. Date: Aug. 13, 2015

(54) SAFETY SYSTEM TO PREVENT OR DECREASE DISTRACTED DRIVING CAUSED BY THE USE OF A CELL PHONE IN A VEHICLE

(71) Applicant: Justin McGuire, Rapid City, SD (US)

(72) Inventor: Justin McGuire, Rapid City, SD (US)

(21) Appl. No.: 14/178,487

(22) Filed: Feb. 12, 2014

(51) Int. Cl. H04W 4/00; H04W 60/00

(52) U.S. Cl. CPC H04W 4/008; H04W 60/00

(57) ABSTRACT

An apparatus to prevent distracted driving of a vehicle due to use of a cell phone includes: a cell phone holder adapted to hold a cell phone in a position such that its buttons, keyboard, or touchscreen cannot be accessed; a registration system for registering a cell phone with the apparatus; a short range detector for detecting whether or not the registered cell phone is located in the cell phone holder; and a vehicle enabling/disabling circuit, responsive to the short range detector, for preventing the vehicle from being operated if the registered cell phone is not located in the cell phone holder and for enabling operation of the vehicle if the registered cell phone is in the cell phone holder.

### BACKGROUND

1. Technical Field

This disclosure pertains to cell phones and smart phones, and, in particular, devices and methods to prevent use of cell phones and smart phones while driving.

2. Background

It is known that the use of cell phones while driving is the cause or one of the causes of many vehicle accidents. Many serious injuries and deaths have resulted from distracted driving directly caused by the use of a cell phone. In fact, distracted driving kills more people than drunk driving. The wide range of activities available on mobile devices—including texting, checking email, using navigation, and even playing games while driving—exacerbates this problem. Increasingly larger volumes of data, such as pictures or songs, requires increasingly lengthy searches and increasingly more browsing time to locate that one desired file within a large volume of data, particularly when the user is unsure of the exact file name or its location. One solution to this has been the hands-free cell phone. This solution is hampered by the fact that it takes time and skill to install a hands-free system in a car. Moreover, every cell phone has to be separately installed. However, every time a car battery is disconnected, which happens routinely in car servicing, the hands-free system has to be reinstalled, often for several cell phones. Further, cell phones are constantly evolving, cell phones are lost, or cell phones are incapacitated by a slight amount of water or by dropping them. Each time a person replaces a cell phone, each time a cell phone is incapacitated, and each time some other part of the cell phone system is changed, the hands-free system(s) must be reinstalled. Further, hands-free cell phones really address only the telephone function of smart phones and do not address other uses. Further, hands-free systems usually are not completely hands-free, as they usually require picking up the phone and pushing one or more buttons before issuing a hands-free command. For this and many other reasons, hands-free systems have not been effective to reduce or end the distracted use of cell phones and smart phones while driving.

Another solution has been adding software applications to a cell phone or vehicle to electronically block use of cell phones or smart phone functions in vehicles while they are moving. Since these systems are electronic, they easily can be disabled or avoided by hacking or other electronic measures. One of the major problems with software applications as they pertain to a parent keeping their children from texting and driving is that most teenagers know more about software technology than their parents who are trying to limit cell phone use. The never-ending cat and mouse game of child vs. parents has taken a new twist in the technology age. Because the children generally know more about the technology, they can find workarounds to easily bypass any restrictions their parents tried to enforce. One of the fastest and most effective workarounds that teenagers use to bypass any software application that places restrictions on their phone is the use of a task-manager program. The use of task-managers is fairly common place knowledge among young people today. One task-manager function is to terminate an application running in memory. Generally, they are used to terminate unresponsive programs that may have encountered an error so that you can either restart the application or free up your phone's memory so that it will work faster. Many young people have learned that task-managers can be conveniently used to disable applications that give them problems with a single click.

In addition, many of the software applications that are designed to prevent cell phone use while driving are quite complex. For example, one program produced by AT&T has at least six expandable menus that must be understood to operate the system. Such complexity provides a disincentive to use the system. Further, some of these systems run afoul of Federal law that bans use of a cell jammer or similar devices that intentionally block, jam, or interfere with authorized radio communications such as cell phones, police radar, GPS, and Wi-Fi.

For these reasons, the problem of distracted driving caused by cell phone or smart phone use is escalating with each generation of cell phone that can do more. The National Transportation Safety Board has included elimination of distracted driving in its ten most wanted list of transportation safety improvements. Thus, a system or apparatus that prevents distracted driving caused by use of cell phones and smart phones would be highly desirable.

### BRIEF DESCRIPTION OF THE DRAWINGS

The invention will become clearly understood from the following detailed description read together with the drawings in which:

FIG. 1 is a diagrammatic view illustrating an example of a safety system that decreases or prevents distracted driving by use of a cell phone in a vehicle;

FIG. 2 is a diagrammatic view illustrating one embodiment of a safety system and process for reducing or preventing distracted driving;

FIG. 3 is a block electrical circuit diagram illustrating one embodiment of the electronics of a safety system to prevent or decrease distracted driving;

FIG. 4 is a diagrammatic view illustrating several possible embodiments of a communication system that may be used with an embodiment of a safety system;

FIG. 5 illustrates an embodiment of a smart phone that may be incorporated into any one of the safety systems illustrated above;

FIG. 6 illustrates another embodiment of a safety system that decreases or prevents distracted driving by use of a cell phone in a vehicle;

FIG. 7 is a flow chart illustrating an embodiment of a safety process to decrease or prevent distracted driving by use of a cell phone;

FIG. 8 is a flow chart illustrating an embodiment of a process for utilizing any one of the safety systems illustrated above;

FIG. 9A is a flow chart illustrating an embodiment of part of a process for utilizing a built-in model of the safety systems illustrated above;

FIG. 9B is a flow chart illustrating an embodiment of part of a process for utilizing a built-in model of the safety systems illustrated above;

FIG. 9C is a flow chart illustrating an embodiment of part of a process for utilizing a built-in model of the safety systems illustrated above;

FIG. 9D is a flow chart illustrating an embodiment of part of a process for utilizing a built-in model of the safety systems illustrated above;

FIG. 10A is a flow chart illustrating an embodiment of part of a process for utilizing an add-on model of the safety systems illustrated above;

FIG. 10B is a flow chart illustrating an embodiment of part of a process for utilizing an add-on model of the safety systems illustrated above; and

FIG. 10C is a flow chart illustrating an embodiment of part of a process for utilizing an add-on model of the safety systems illustrated above.

### DETAILED DESCRIPTION OF THE DRAWINGS

Embodiments disclosed herein relate to method and apparatus for preventing distractions due to use of cell phones, smart phones, and similar electronic devices while driving. In this disclosure, the term cell phone includes smart phones and other electronic communications devices which have the capability of distracting a user while driving.

It will be useful in understanding the embodiments described herein to begin by placing them in the context of other systems designed to prevent use of cell phones while driving. As mentioned above, there are systems that prevent use of a cell phone, smart phone, or other electronic communication devices while driving by electronically disabling the electronic communication device. Most detect when the car is moving and then jam the electronic communication or prevent its transmission in some way. Another system provides a device that encloses a car key. The device communicates with the cell phone wirelessly. To turn on the engine, the driver must either slide the key out or push a button to release it. When this is done, the device sends a signal to the cell phone which triggers the cell phone into a mode in which the phone is disabled. For example, it may place a “stop” sign on the phone's display screen. Neither the enclosed key device or any other device that disables the cell phone get at the root of the problem, i.e., distraction by the cell phone, smart phone, or other electronic communication device.

A fundamental problem with devices that disable the electronic device is that the device is still available. A user may not be aware of the disabling feature and fumble around trying to use the device, thereby being distracted. Further, since such devices rely on a signal going to the electronic device, the signal or the safety device itself can be easily disabled by blocking this signal.

In one sense, the embodiments described herein disable the vehicle instead of electronically disabling the electronic device. This concept is a bit shocking when first encountered, as fears of not being able to use the vehicle or phone, say in an emergency or the vehicle stopping suddenly while being driven, can arise. However, as will be seen in the following, these fears are overcome by the embodiments described.

The embodiments described herein, when considered carefully and rationally, make much more sense than the systems that electronically disable the cell phone. In one sense, the cell phone or smart phone is mechanically disabled by requiring the cell phone or smart phone to be physically put away so that it is inaccessible. However, it can still be used by appropriate, non-distracting cell phone systems, such as by a hands-free device. The embodiments described, when viewed from this aspect, force the user to use a safe method of operating the cell phone or smart phone.

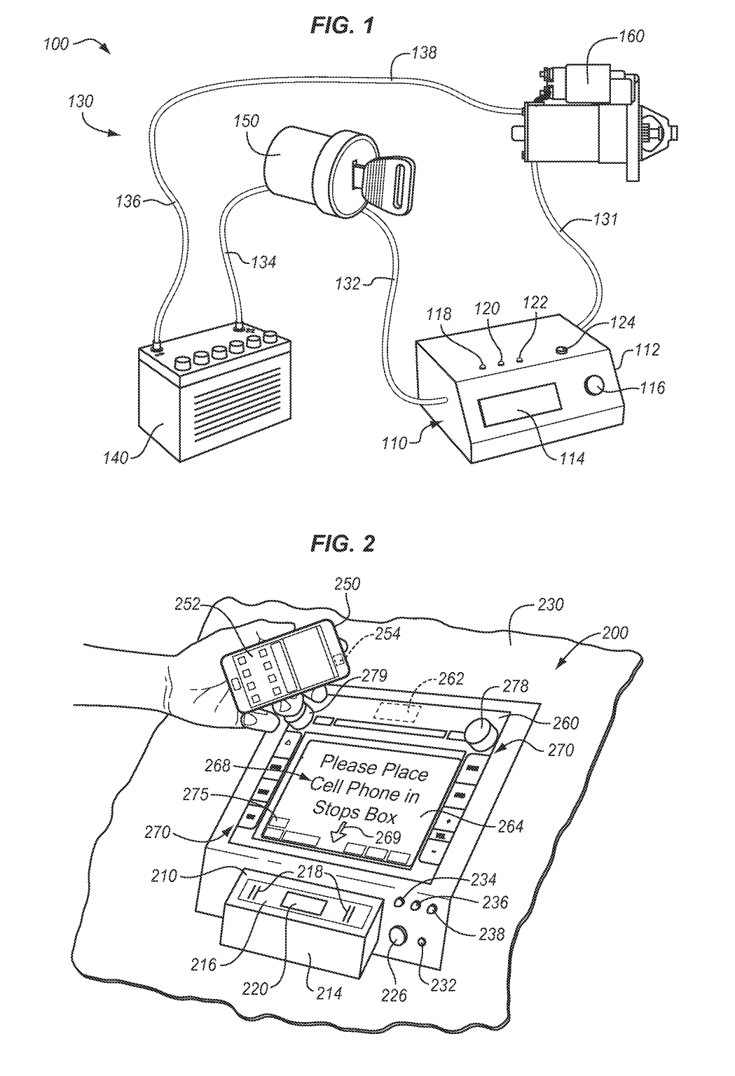

FIG. 1 is a diagrammatic view illustrating an example of a safety system 100 that decreases or prevents distracted driving by use of a cell phone in a vehicle. System 100 includes a stops box 110, a power source 140, such as a car battery, vehicle starter 160, and a switch 150, such as a vehicle ignition switch, all of which are connected into a circuit 130 by conductors such as 131, 132, 134, 136, and 138. Stops box 110 includes an enclosure 112, a phone compartment 114, a phone compartment open/shut controller 116, LEDs 118, 120, and 122, and a reset switch access opening 124. As will be seen below, stops box 110 includes an enclosure in which a cell phone, that may otherwise cause distraction, may be placed to prevent such distraction. As will also be seen below, in some embodiments, stops box 110 is a type of lock box. It is referred to herein as a stops box to suggest the fact that it may take many other forms so long as it prevents any attempt at handling of the phone or other electronic device that may cause distraction while driving.

FIG. 2 is a diagrammatic view illustrating one embodiment of a safety system 200 and illustrating part of a process for reducing or preventing distracted driving. System 200 includes stops box 210, vehicle 230, only a portion of which is shown, a smart phone 250, and a combination navigation/entertainment unit 260. Phone 250 includes operating controls 252, which may include a keypad 252. The keypad may include physically separate keys, a touch screen pad, or any other equivalent structure. In this embodiment, navigation/entertainment unit 260 is built into the vehicle, such as an automobile, and stops box 210 is built into the navigation/entertainment unit 260. Stops box 210 comprises a drawer 214, having an enclosure space 216 which is enclosed, so that whatever is in it cannot be accessed when drawer 216 is closed, a short range detector 220 which may comprise a reader 220, an open/close mechanism 226, which may be a mechanical or electrical device, a reset switch access port 232, and LEDs 234, 236, and 238. Short range detector/reader means that the range of the detecting/reading device is essentially limited to the interior of enclosure 216. Brackets, such as 218, may be designed to hold the registered phone or phones in place. A vehicle range reading device 262 is built into the unit 260 and may be considered part of the stops box 210. Vehicle range reading device means that the device communicates within a range that includes the interior of the vehicle. Unit 260 also includes a display 264, various controls 270, touch screen elements such as 275, and knobs 278 and 279. Any of these controls 270, touch screen elements such as 275, and knobs 278 and 279 may be used in controlling stops box 210 in some embodiments.

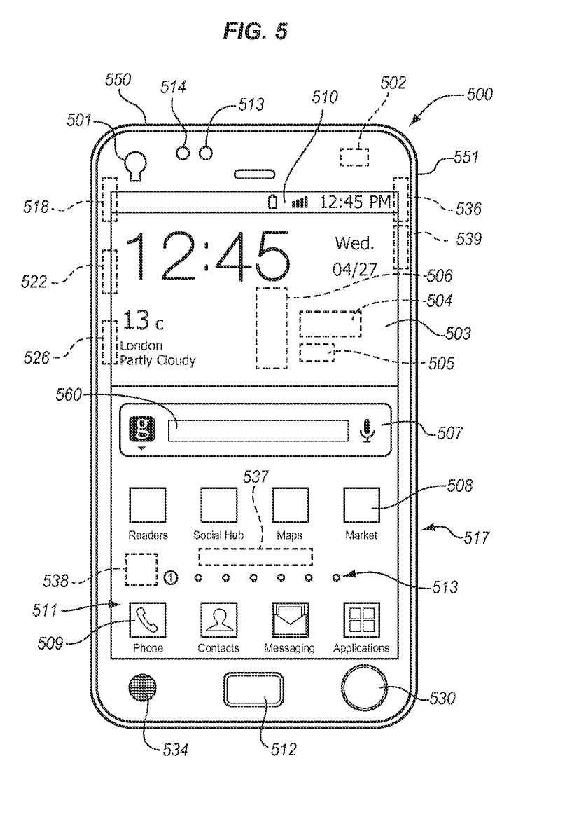

System 200 also includes cell phone or smart phone 250, which includes vehicle range broadcasting device 254. Phone 250 represents a typical cell phone, smart phone, or other electrical device that may cause distraction when operating the vehicle 230, and which in embodiments herein must be stored in stops box 210 to permit operation of vehicle 230. Phone 250 will be described in more detail in reference to FIG. 5. In the embodiment of FIG. 2, display 264 is operating as part of stops box system 210 by displaying the message 268 “Please Place Cell Phone in Stops Box” and the arrow 269 pointing to the stops box 210.

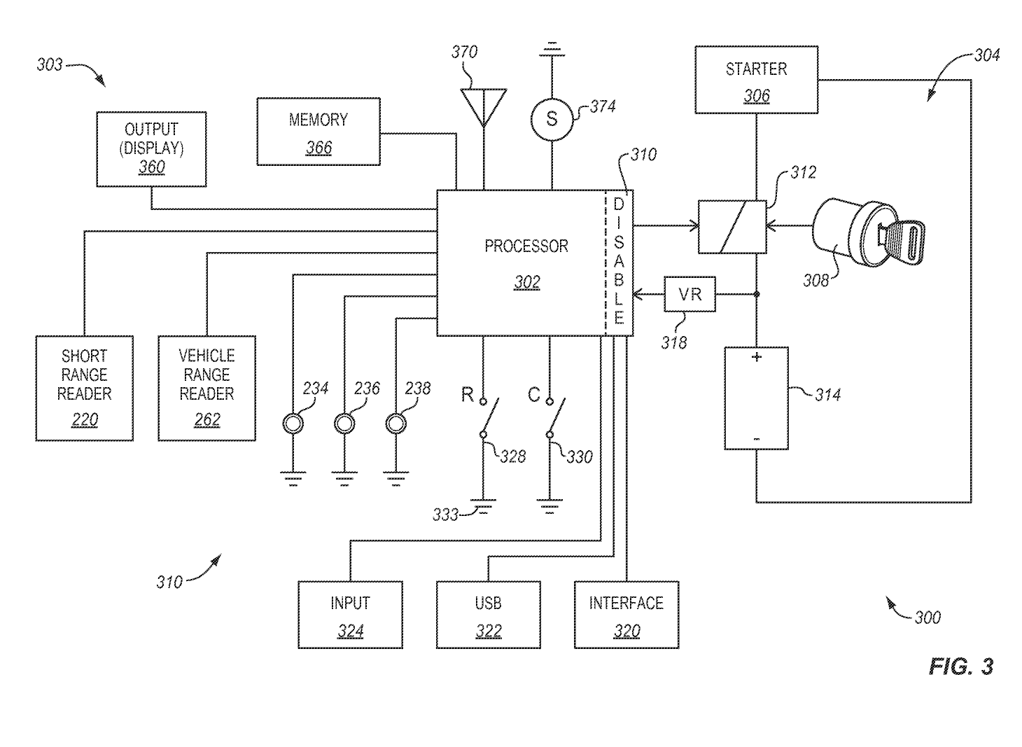

FIG. 3 is a block electrical circuit diagram 300 illustrating one embodiment of a circuit 300 that may be included within a vehicle to implement the stops system. The electronics may include stops box electronics 310 to prevent or decrease distracted driving. Stops box electronics 310 is shown in a different aspect than stops box 110 or 210 to better illustrate this embodiment. Electronics 300 includes an electronic processor 302, which may be a programmable logic chip, a programmable gate array, a microprocessor, or other control logic chip. In the embodiment of FIG. 3, it is a microprocessor. Electronics 300 also includes starter 306, starter switch 308, a vehicle disable device 310, which, in this embodiment, is part of processor 302, a power source 314, which, in this embodiment, is an automotive battery, a relay 312, and a voltage regulator 318. Electronics 300 also includes a USB port 322, other input device or devices 324, such as a keyboard, a mouse or touch screen, an interface 320, a reset switch 328, a check switch 330, LEDs 234, 236, and 238, vehicle range detector which may comprise reader 262, and a short range detector which may comprise reader 220, outputs 360, such as a display, memory 366, antenna 370, and servo motor 374. As in any electronic circuit, most circuit elements are connected between a system voltage and ground. The system voltage inputs are not shown, though some grounds are illustrated as at 333.

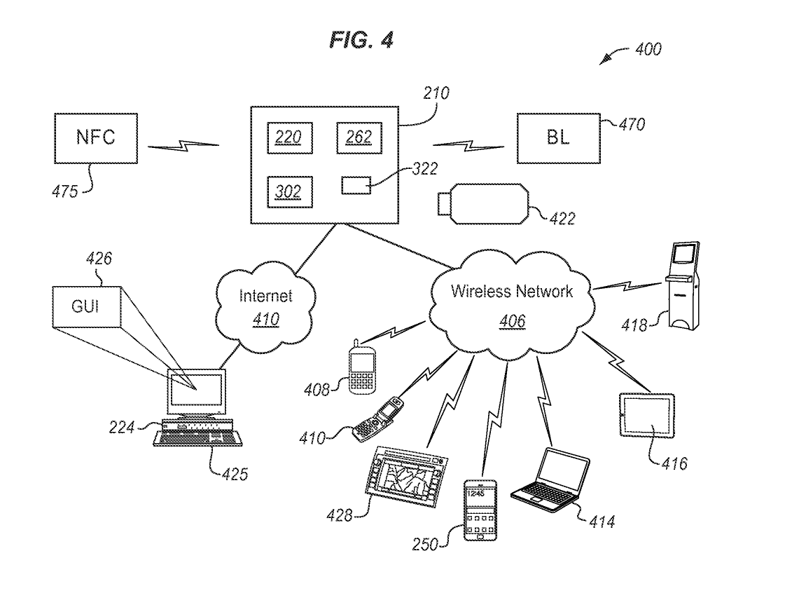

In this embodiment, when start switch 308 is closed, it closes relay 312 which connects battery 314 across starter 306. Disabler 310 operates to prevent relay 312 from closing if a registered electronic device is on in the vehicle but is not in the stops box enclosure. 216. Vehicle disabler 310 may take many other forms. In this embodiment, it operates on relay 312; but it also may operate on starter 306, start switch 308, or on any other portion of the vehicle that is necessary for the vehicle to operate, such as a shifting mechanism. Voltage regulator 318 provides a regulated voltage to processor 302 and other parts of the circuit. In one embodiment, interface 320, input 324, and output 360 may be provided by unit 260 (FIG. 2), though, as discussed below in connection with FIG. 4, they may be provided by a wide variety of other devices. Memory 366 may be memory associated with processor 302, or it may be embedded memory or any other electronic memory associated with vehicle 230. LEDs 234, 236, and 238 are preferably of different colors, such as blue, green, and red. For example, LED 234 may be a blue LED that indicates that the stops box is on, LED 236 may be a green LED that indicates that the stops box is operating properly, and LED 238 may be a red LED that indicates some sort of system failure, such as the presence outside of the stops box enclosure 216 of an operating registered phone. When switch 328 is closed, it causes processor 302 to reset the system 300. When switch 330 is closed, it indicates to processor 302 that the drawer 214 or other enclosure is closed.

In one embodiment, short range detector/reader 220 is contained within the enclosure 216 of the stops box 110, 210, 310, or communicates with the enclosure. Detector/reader 220 may be an electronic socket, such as a USB connector. One part of the socket, such as a female portion, may be built into the cell phone and the other part of the socket, such as the male portion, may be built into the stops box. In either case, it may be in a fixed position in the stops box or may be at the end of a short cable contained in the stops box. The male and female portions may be reversed. In another embodiment, the short range detector/reader may be a bar code reader in combination with a sticker 537 (FIG. 5) on the back of phone 250, 500, a near field communication (NFC) device with a range such that it will not read any NFC broadcaster outside of enclosure 216, a magnetic reader, or any other detector or reader that has such a short range. Vehicle range detector/reader 262 may be a blue tooth communicator, including a low energy blue tooth (BLE) device, or any other communication device of suitable range. Aerial 370 provides a suitable aerial for short range reader 220 and vehicle range reader 262. Servo motor 374 operates to open and close drawer 214 and operate check switch 330.

FIG. 4 is a diagrammatic view illustrating several possible embodiments of a communication system 400 that may be used with an embodiment of a safety system 210. Communication system 400 may include wireless network 406, various wireless devices such as smart phone 408, cell phone 410, automobile navigation unit 428, laptop computer 414, tablet computer 416, kiosk 418, as well as the phone 250 which is in the stops box, or will be in the stops box. As mentioned above, communication system 400 may also include Bluetooth device 470, and NFC device 475, as well as the short range detector/reader 220 and vehicle range detector/reader 262 within stops box system 210. Communication system 400 may also include a token 422, which may be a USB stick which can be inserted into USB port 322. Many other wireless devices also may be included. System 400 also may include Internet 410, controller computer 224 having an input device 425, such as a keyboard, and a graphical user interface 426. Computer 224 preferably communicates via Internet 410.

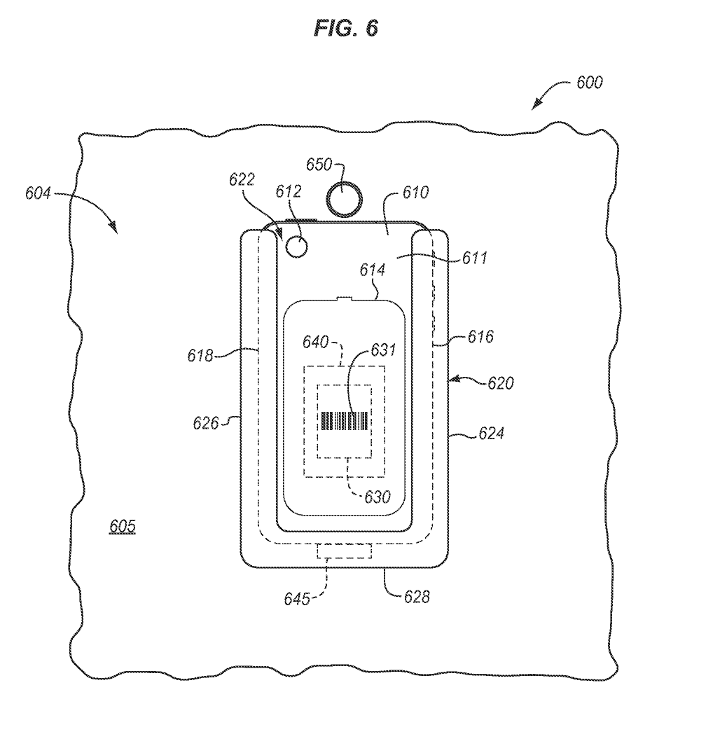

FIG. 5 illustrates an embodiment 500 of an electronic device 550 that may be incorporated into any one of the safety systems illustrated above. Electronic device 250, 550 will be described in this disclosure primarily in terms of a smart phone embodiment 550. However, it should be understood that this embodiment is only exemplary; and device 250 could comprise any electronic communication device that is capable of causing distracted driving. Smart phone 550 in one embodiment comprises near field short range transceiver 501, blue tooth vehicle range transceiver 502, display 503, and internal electronics including a memory 504, clock 505, and microprocessor 506. Display 503 preferably comprises a touch screen having function specific areas, such as search area 507, touch screen buttons 508, which provides links to Internet sites, and touch screen buttons 511 which activate particular functions of the device 550, all of which buttons are identified by icons, such as phone icon 509. Display embodiment 503 also includes time and date area 510. Embodiment 550 also includes a hardware switch 512 that allows the user to toggle to the home screen or between different screens. Touch sensitive screen 503 preferably is sensitive to swipes across the screen which permits the user to access different screens, the screen being viewed being indicated by illuminated numbers in area 513. Device embodiment 550 also preferably includes camera 514 and light sensor 513. Other sensors, such as magnetometer 518, global positioning system (GPS) 522, proximity sensor 526, finger print sensor 530, microphone 534, and accelerometer 538 also may be present. Phone 550 also may include a broadcast device 536 for broadcasting a phone identification signal and a USB port 539. In this embodiment, the USB port 539 may connect with a USB connector on a cable in the stops box drawer 214; and in other embodiments, the USB port 539 may be at the bottom of the phone to connect to a USB connector, such as 645 in holder 620 (FIG. 6). In one embodiment, phone 550 includes bar code reader 560 as an alternative form of short range detector/reader. This bar code reader would be designed to read a bar code such as 631 (FIG. 6) in the stops box drawer or sleeve. Alternatively, the phone 500 may include a sticker 537, which is shown in ghost in FIG. 5 as, in this embodiment, it may be on the back of the phone to be read by a sensor 220 in the stops box drawer 214 or an electronically sensitive sticker containing an NFC tag, for example. Other sensors may also be included. Smart phone 550 is enclosed and protected by a hard case 551.

FIG. 6 illustrates another embodiment of a safety system 600 that decreases or prevents distracted driving by use of a cell phone in a vehicle. System 600 includes a phone 610, a stops box comprising a stops box phone holder 620, and a lock 650. Phone holder 620 is mounted on a wall portion 605 of a vehicle, such as an automobile. Phone 610 includes case 611, camera lens 612, battery cover 614, and short range element 630. Stops box holder 620 includes first side support 624, second side support 626, bottom support 628, and short range detector/reader 640. Short range detector/reader 640 interacts with short range element 630 to allow the system 600 to determine whether the phone 610 is in the holder 620. For example, short range reader 640 may be a bar code reader and short range element 630 a bar code 631, which may be located on a sticker 630. In another embodiment, short range element 630 is an NFC tag, and short range reader 640 is an NFC device. Alternatively, short range detector/reader 640 may be on phone 610 and short range element 630 may be on the holder. First side support 624, second side support 626, and bottom support 628 form a sleeve or pocket 622. Pocket 622 is of a size that will slidably receive phone 610. One side 616 of phone 610 fits under support 624, and the other side 618 of phone 610 fits under support 626. Lock 650 may be a rod-like button, similar to a car lock button that pops out and locks cell phone 610 in holder 620 when the vehicle is started, and retracts when the vehicle slows below a predetermined speed or stops or the vehicle shift lever is put in park or other suitable condition(s) are met. Holder 620 may be located on the vehicle dashboard, on the side wall of a compartment, such as a glove compartment or storage compartment in an arm rest, or any other suitable surface of a vehicle. In one embodiment, phone 610 is slid into holder 620 with the keypad 252 or equivalent operational controls of the phone facing the wall 605 so the keypad cannot be seen. Holder 620 may include contacts 645, such as in a USB port, to charge the phone 610 while it is in pocket 622. Contacts 645 also may be used to place the phone in a hands-free mode in which it connects to a hands-free system in the vehicle. At the same time, the contact maybe used to indicate to system 300, 600 that a particular registered cell phone is in sleeve 622.

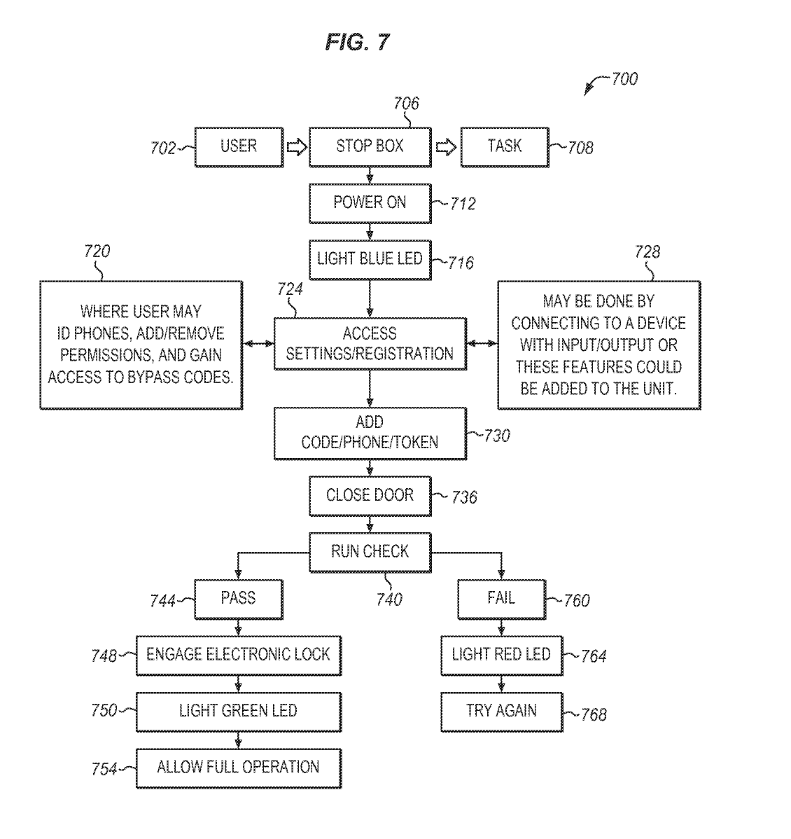

FIG. 7 is a flow chart 700 illustrating an embodiment of a safety process to decrease or prevent distracted driving by use of a cell phone. Process 700 proceeds by the user at 702 activating functions of the stops box 110, and the stops box 110 responding to perform requested tasks at 708. At 712, the stops box is powered on. Light blue LED 118 is illuminated at 716 to indicate to the user that the stops box has responded and the power is on. The system then goes to condition 724 in which various settings of the stops box may be set or adjusted; and individual electronic devices, such as smart phones, may be registered on the system. Some of these processes are indicated at 720, such as identifying pones, add or remove permissions, and access bypass codes. As indicated at 728, these sub-processes may be performed by connecting stops box 110 to an input/output device, such as computer 425 (FIG. 4), laptop 414, navigation/entertainment system 428, smart phone 408, or tablet 414. Alternatively, the input/output features may be added to the stops box unit 110. At 730, a typical sub-process is illustrated: a code, a phone, or a token may be entered into memory 366 (FIG. 3). At 736, a registered phone has been placed in drawer 114, 214, or pocket 622, and the door 114, 214 is closed, or lock 650 is extended. At 740, an alternative optional check sub-process is run.

In one possible embodiment, if a registered phone is in the stops box and there is no registered phone that is in the vehicle but not in the stops box, the lock servo 374 and lock 650 are operated to lock the registered phone in the stops box at 748, then light green LED 120 is lit. Relay 312 is closed, and full operation of the vehicle is allowed at 754. If the indicated registered cell phone is not in the stops box, or a registered cell phone is in the vehicle and not in the stops box, a check fail is indicated at 760 and red LED 122 is lighted at 764. The cell phone then can be placed in the stops box and the run check sequence run again at 768.

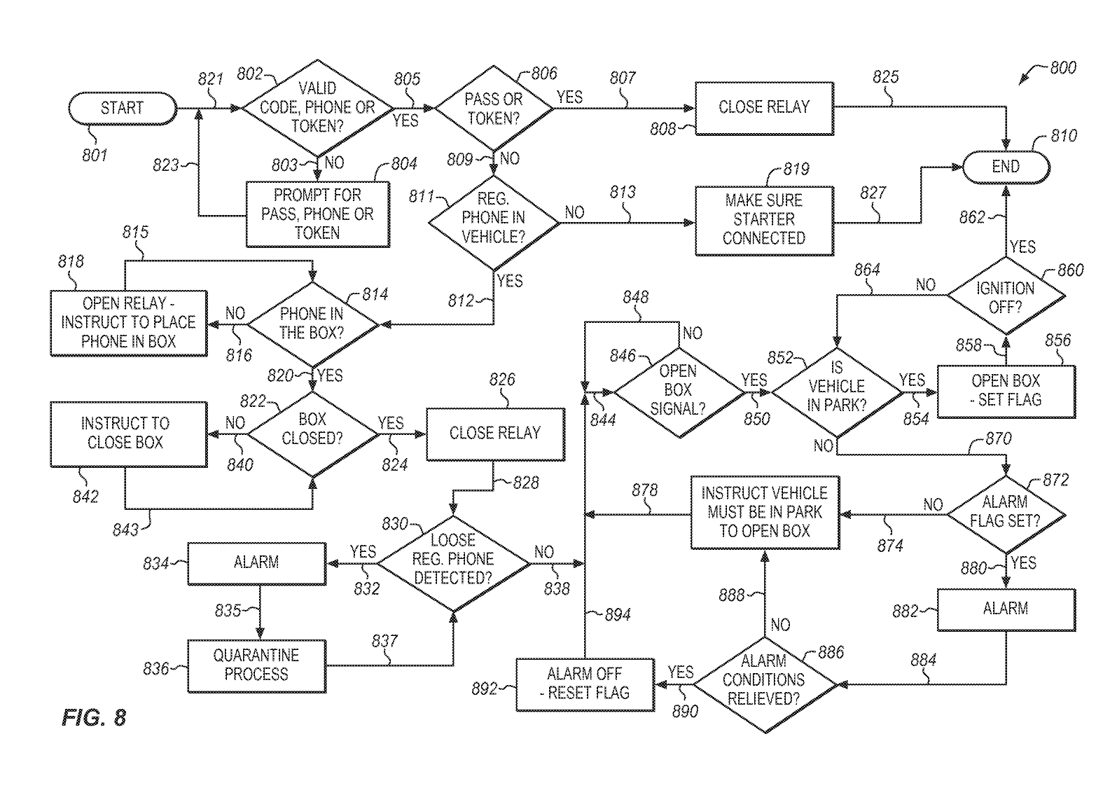

FIG. 8 is a flow chart illustrating an embodiment of a process 800 for utilizing any one of the safety systems illustrated above. In one embodiment, the default condition is that relay 312 is open with the ignition switch 308 being in the off state. Process 800 starts at 801. System 110, 300, 400, 600 first checks at 802 to determine: if a valid token, such as a USB stick with a valid code in its memory is inserted into USB port 322; if a valid pass code has been entered on input 324; or if there is a registered cell phone 252 in the vehicle. It does the latter by using the vehicle range detector, such as 262, to communicate with the cell phone's vehicle range broadcaster, 254, 502. In one embodiment, the cell phone 250 is a brand which broadcasts its presence and, at 802, it is determined if any cell phone is in the vehicle. If no valid token is present, no valid code has been entered, and no registered phone is present, at 804 the system prompts the user to connect the token, enter a code, or provide a cell phone. Sub-process 802 may be triggered by placing the car key in the ignition, by attempting to start the vehicle using a fob, or any other mechanism that may be used to start the vehicle. It also may be initiated by providing an input into system 300 via an input 324. Since this is an electronic check, it may be done so quickly that it is not noticed by the person starting the vehicle. There may be a fraction of a second delay in the starter responding to the ignition switch, but this normally would not be noticed. Once there is a valid token or code entered or a phone is present, system 800 goes to 806 via path 805. At 806, system 800 determines if a token has been inserted or pass code has been entered and, if so, goes to 808 via path 807, closes relay 312, and the process ends at 810. If there is no token present or valid pass code entered, system 800 goes to 811 via path 809 and checks to see if the phone is registered; that is, is it a phone that the user's parents or other user of the system wants to control. If there is no registered phone in the vehicle, the system goes to 819 via path 813 and makes sure relay 312 is closed and starter 306 is connected in the circuit with battery 140, 314, and the process ends at 810. If a registered cell phone is detected in range, process 800 goes to 814 via path 812. At 814, process 800 checks to see if the registered cell phone(s) is/are in the stops box 110, 210, and 620.

In another possible embodiment, if there is a registered phone that is not in the stops box, the system may open relay 312 and process 800 may proceed via path 816 to sub-process 818, open relay 312, and provide instructions to place the cell phone in the stops box. These instructions may be initiated by using a display, such as 264, by voice instructions, or both or other method, such as a flashing reminder light or a warning sound, such as a buzzer. The warning light can be on the dashboard, the stops box, or other location. In either case, the system recycles to 814 via path 815. If the detected phone(s) is/are in the stops box, process 800 proceeds to sub-process 822 via path 820 and checks to see if the stops box is closed or, alternatively, lock 650 is extended. If not, the system proceeds to sub-process 842 via path 840 and provides instructions to close the stops box. Again, this may be by way of instructions on a display, such as 264, via voice instructions, or some other way, such as a flashing reminder light. If the stops box is closed or lock 650 is extended, the system proceeds via path 824 to 826, and relay 318 is closed or the starter is otherwise connected in series with battery 140, 314.

Once the vehicle is operating, in a possible embodiment, process 800 may proceed via path 828 into a semi-quiescent state 830 in which it may regularly check to determine if there is a registered electronic device loose and turned on in the vehicle. If there is, process 800 may proceed via path 832 to 834 where an alarm having a preset reset time is turned on. The alarm may be an audio alarm, a visual alarm, or both. The system may then pass to 836 via path 835 and enable a cell phone quarantine sub-process, which may require the device to be disabled, such as turned off, or may permit the stops box to be opened and the phone inserted. The system then cycles via 837, 830, 832 and 834, 835, 836 until the electronic device is disabled or placed in the stops box quarantine. Once the loose cell phone is corralled, system 800 proceeds to 846 via 838 and 844, and the alarm turns itself off at the preset time. At 846, system 800 waits for a signal asking that the stops box be opened. If there is no such signal, system 800 follows path 848 and continues to wait for a signal. If system 800 detects a signal, control passes via path 850 to 852, where it checks to see if the vehicle is in park or, alternatively, at or below a predetermined low speed. If the vehicle is not in park or otherwise in condition to allow the electronic device to be used without creating a dangerous distraction, the process passes to 876 via path 870, 872, and 874; and instructions are provided that the vehicle must be in park to open the stops box, or some other appropriate instruction, which may be audio, visual, or both. Since the stops box is closed at this point, the stops box open flag is not set, and no alarm provided at 872. Process 800 then cycles via 878, 844, 846, 852, 870, 872, and 874 until the vehicle is in park, there is no open box signal, or another appropriate condition is reached. Once the vehicle is in park, process 800 then proceeds to 856 via path 854, and the stops box is opened, lock 650 released, or other appropriate function is performed, and a box open flag is set. Process 800 then goes via path 858 to 860, where it is determined if the ignition is off. If the ignition is not off, process 800 circles to 852, and if the vehicle is not in park, goes to 872 via path 870. Since, in this case, the box open flag is set, the process proceeds to 882 via path 880, and an alarm is provided at 882, which may be audio, visual, or both, or any combination of a suitable process of communication. The process then proceeds via 884, 886, 888, 876, 878, 844, 846, 850, 852, 870, 872, 880, 882, 884, and 886 until the alarm condition is relieved, e.g., the stops box is closed with the cell phone in it, the alarm is turned off, and the open flag is reset at 892. The process may then either cycle through 876, 846, and 852 until the vehicle is placed in park, and then cycle through 856 and 860 until the ignition is off. If the ignition is off, the process goes to end 810 via path 862, and stays quiescent until the process is triggered again by the ignition being turned on or other appropriate signal.

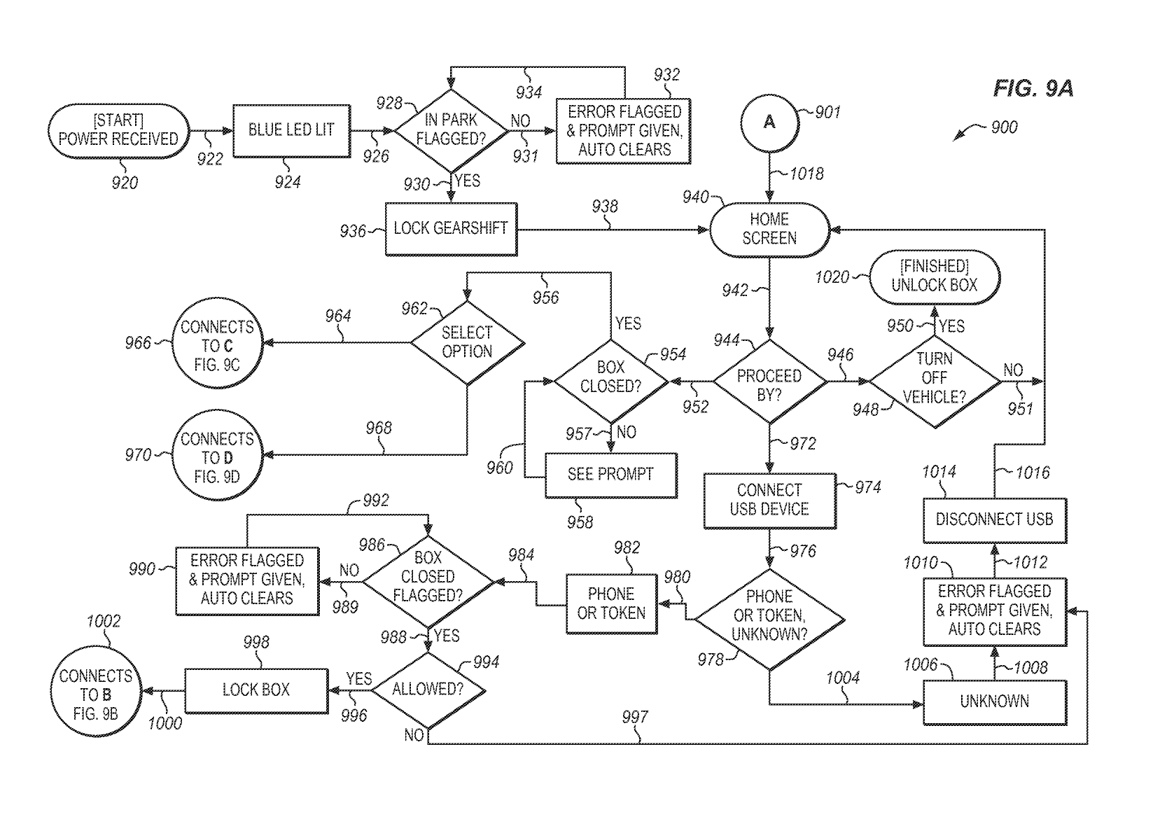

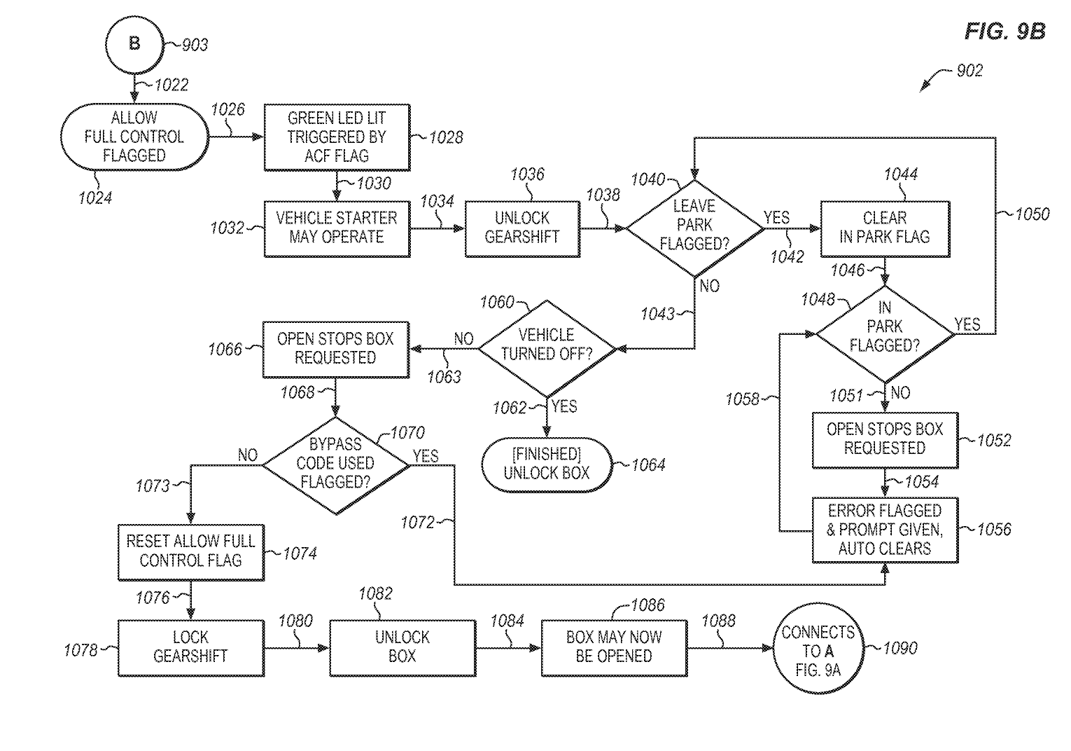

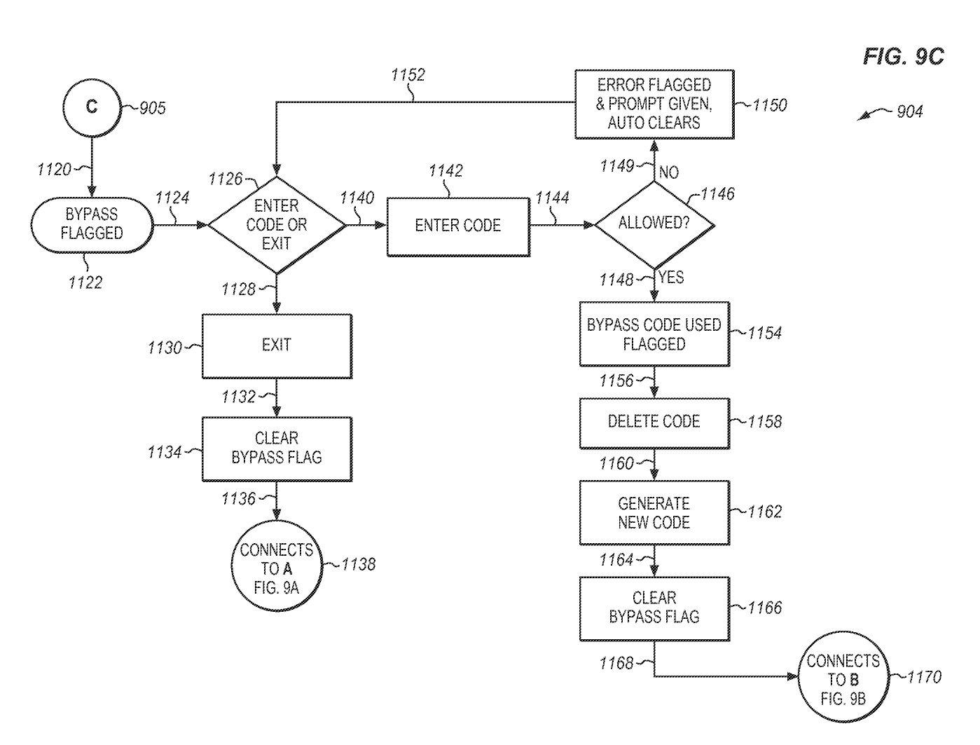

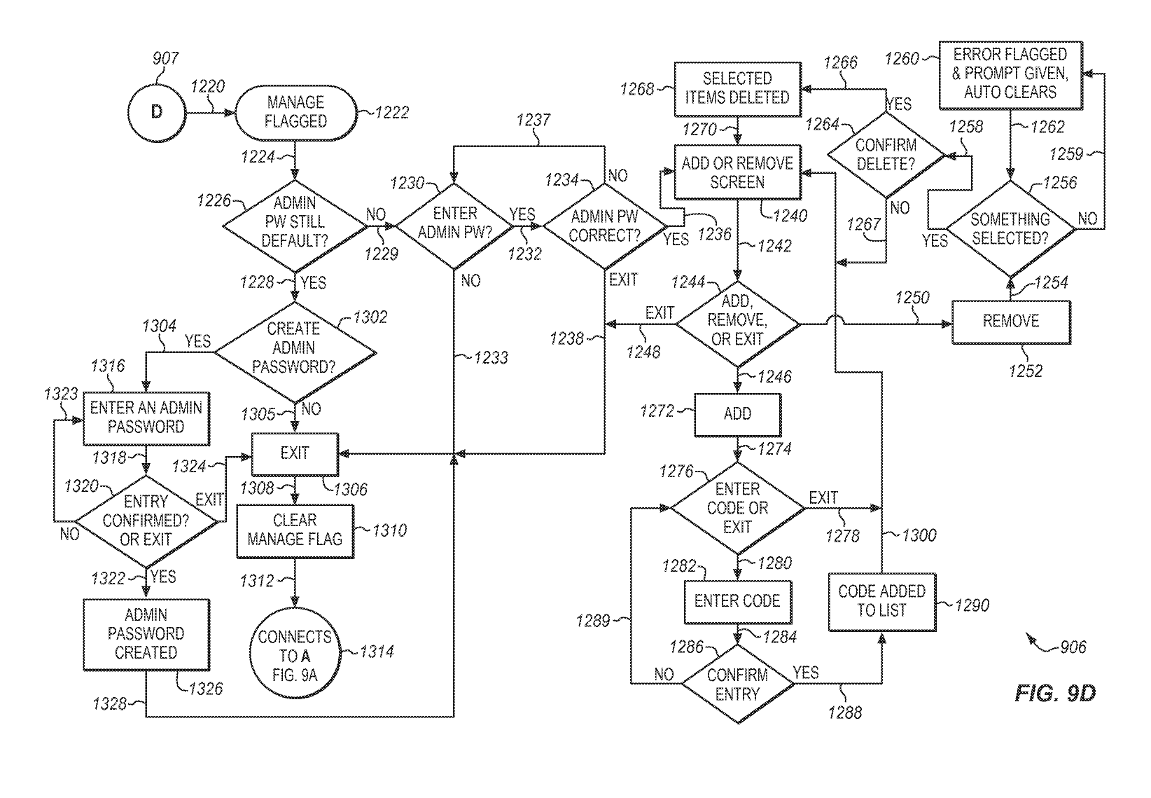

FIG. 9A is a diagram showing part of the arrangement of FIGS. 9A, 9B, 9C, and 9D which together illustrate an embodiment of a process for utilizing a built-in model of the safety systems illustrated above. FIG. 9A process 900 contains one embodiment of a pre-check function coupled together with one embodiment of a Home Screen function. Access to this figure from any other figure is made available by portal A 901. The pre-check function starts when the stops box receives power 920. In this embodiment, a blue LED is lit to indicate power is being received 924. If case 928 (In Parked Flagged?) is in false condition 931, the pre-check would fail, an error flagged, and a prompt given that auto clears. If case 928 (In Parked Flagged?) is in true condition 930, the gearshift would be locked and the user taken to the home screen. This ends the pre-check function and starts the home screen function. The user has several options now: the user may close the stops box and select an option to manage the device or use a bypass code 962, connect a USB device 974, or turn off the vehicle ending the process 948. If case 978 (Phone or Token, Unknown?) is in condition 1004 unknown, the user is set on routes 1004, 1006, 1008, 1010, 1012, 1014, and 1016. There, in USB device was unknown 1006, an error is flagged and a prompt given that will auto clear 1010 (in which the user was asked to disconnect the USB device and try again), the USB was disconnected 1014, and the user returned to the home screen 940. If case 978 (Phone or Token, Unknown?) is in condition 980 phone or token, the user must close the stops box 988 for the allowed check 994 to run. If the stops box is not closed, an error is flagged and a prompt given that will auto clear 990. If the stops box was closed and the allowed check 994 ran unsuccessfully 997, an error is flagged and a prompt is given 1010 that will auto clear (in which the user was asked to disconnect the USB device and try again), the USB was disconnected 1014, and the user returned to the home screen 940. If the stops box was closed and the allowed check 994 ran successfully 996, the stops box will engage the electronic lock 998, locking the device inside. The user is set on route 1000, 1002, 903, 1022, and 1024. The user then is granted full control when allow full control is flagged 1024. If the user chooses to close the stops box and select option 962, the user could choose bypass 964 or manage 968. If the user chooses bypass option 964, the user would be set on route 966, 905, 1120, and 1122. The bypass is flagged 1122 and the bypass function started. If the user chooses manage option 968, the user would be set on route 970, 907, 1220, and 1222. The manage function is flagged 1222 and the manage function started. If the user chooses to turn off the vehicle 950, the program is ended and the stops box unlocked 1020.

FIG. 9B is a diagram showing part of the arrangement of FIGS. 9A, 9B, 9C, and 9D which together illustrate an embodiment of a process for utilizing a built-in model of the safety systems illustrated above; FIG. 9B process 902 contains one embodiment of an Allow Full Control function. Access to this figure from any other figure is made available by portal B 903. Once any predetermined condition is met, allow full control is flagged 1024. In this embodiment, a green LED is lit, triggered by the allow full control function flag 1028 letting the user know control has been gained. At nearly the same moment, the vehicle's starter may now operate 1032 and the gearshift is unlocked 1036. The user now has the option to leave park or to remain parked 1040. If case 1040 (Leave Park Flagged?) is in false condition 1043, the software waits to see if the user turns off the vehicle 1060 or requests the stops box be opened 1066. Should the user choose to turn the vehicle off 1062, then the program ends 1064. Should the user choose to open the stops box 1068, the software needs to know if a bypass code was used 1070. If case 1070 (Bypass Code Used Flagged?) is in true condition 1072, then an error is flagged and a prompt given that will auto clear 1056. This is one way to ensure that the user does not lose full control until the user has chosen to end the process by turning the vehicle off 1020 or 1064. If case 1070 (Bypass Code Used Flagged?) is in false condition 1073, the user is set on route 1074, 1076, 1078, 1080, 1082, 1084, 1086, 1088, 1090, 901, 1018, and 940. The allow full control flag was reset 1074, the gearshift locked 1078, the stops box unlocked 1082, and the user returned to the home screen 940. If case 1040 (Leave Park Flagged?) is in true condition 1042, the in park flag is cleared 1044. At this point, the software waits to see if the user puts the vehicle back in park 1048 or requests the stops box be opened 1052. If the user request the stops box be opened while the vehicle is not in park, that request will be denied, an error flagged, and a prompt given that will auto clear 1056.

FIG. 9C is a diagram showing part of the arrangement of FIGS. 9A, 9B, 9C and 9D which together illustrate an embodiment of a process for utilizing in a built-in model of the safety systems illustrated above; FIG. 9C 904 contains one embodiment of a Bypass function. Access to this figure from any other figure is made available by portal C 905. Once any predetermined condition is met allow full control becomes flagged 1122. In this embodiment the function first checks to see if the user would like to continue 1126. If the user does not wish to continue condition 1128 the user is set on route 1128, 1130, 1132, 1134, 1136, 1138, 901, 1018, and 940. There-in the user chose to exit 1128, did exit 1130, the bypass flagged was cleared 1134, and then the user was returned to the home screen 940. If the user was to continue successfully through the bypass process the user may take route 1140, 1142, 1144, 1146, 1148, 1154, 1156, 1158, 1160, 1162, 1164, 1166, 1168, 1170, 903, 1022, and 1024. There-in the user requested to enter a code 1140, entered that code 1142, the code was checked against the allowed list 1146, the code was allowed 1148, bypass code used became flagged 1154, the used code was removed from the list 1158, a new code generated in its place 1162, the bypass flag cleared, and full control given to the user 1024. The user may fail to successfully use a bypass code by choosing to exit 1128 or by entering an invalid code 1149. If the user did enter an invalid code an error flagged and a prompt would be given that auto clears 1150. The user is then are given the option to try again or exit 1126.

FIG. 9D is a diagram showing part of the arrangement of FIGS. 9A, 9B, 9C, and 9D which together illustrate an embodiment of a process for utilizing a built-in model of the safety systems illustrated above. FIG. 9D process 906 contains one embodiment of a Manage function. Access to this figure from any other figure is made available by portal D 907. Once any predetermined condition is met, the manage function becomes flagged 1222. Each time the user enters the manage function, the manage function first checks if the admin password is still set at default 1226, possibly meaning the admin password has not been created or the stops box has been reset. If case 1226 (Admin Password Sill Default) is in true condition 1228, the user will be given the option to create the admin password 1302. If the user was to successfully create an admin password, the user may take route 1302, 1304, 1316, 1318, 1320, 1322, and 1326. The user then may enter the password they would like to use 1316. The user will be shown what they had entered as a password and asked to confirm they want to use that entry 1320. If case 1320 (Entry Confirmed? or Exit) is in true condition 1322, the admin password is created 1226. The user then will be redirected to the home screen 940 via route 1328, 1233, 1306, 1308, 1310, 1312, 1314, 901, 1018, and 940, where the manage function was exited 1206, the manage flag cleared 1310, and the user connected back to FIG. 9A process 900 via portal 1314. The ways the user may prolong or fail to successfully create an admin password are 1305, 1323, and 1324; i.e., the user chose not to create admin password 1305, the use had not confirmed their entry 1323, or the user chose to exit instead of continuing 1324. If case 1226 (Admin Password Still Default) is in false condition 1229, the user has already created the admin password and now would be asked to enter the admin password 1230 or exit 1233. If the user chooses to continue with the admin process condition 1232 and enter the password, it then will be checked for accuracy 1234. If the password is incorrect condition 1237, the user may try again 1230 or exit 1233. If the password is in correct condition 1236, the user will see the add or remove screen 1240. The user will have the options to add, remove, or exit 1244. If the user was to successfully add a code to the allowed list, the user may take route 1246, 1272, 1274, 1276, 1280, 1282, 1284, 1286, 1288, 1290, and 1300, where the user entered a code 1276 and then was asked to confirm that entry 1286. The user then confirmed that entry 1288, and the code was added to the allowed list 1290. The user was then taken back to the add or remove screen via path 1300. The ways the user may prolong or fail to successfully add a code to the allowed list are 1248, 1250, 1278, and 1289; i.e., the user chose to remove instead 1250, the user chose to exit the process 1248 or 1278, or the user was unable to confirm their entry 1289. If the user was to successfully remove a code from the allowed list, the user may take route 1250, 1252, 1254, 1256, 1258, 1264, 1266, 1268, 1270, and 1240, where the user has chosen that they want to remove something condition 1250. The user presses the remove option 1252 where the user had something on the list selected to remove condition 1258. The user then was asked to confirm this course of action 1264 and did confirm it condition 1266. The selected items then were deleted by the user's request 1268. The user then is returned back to the add or remove screen 1240. The ways the user may prolong or fail to successfully remove a code from the allowed list are 1246, 1248, 1259, and 1267: the user chose to exit 1248, the user did not have anything selected to delete 1259 (in which an error was flagged and a prompt given that will auto clear under a predetermined condition 1260), and in one embodiment where the condition was that something has be selected, the user decided not to confirm the delete process 1267.

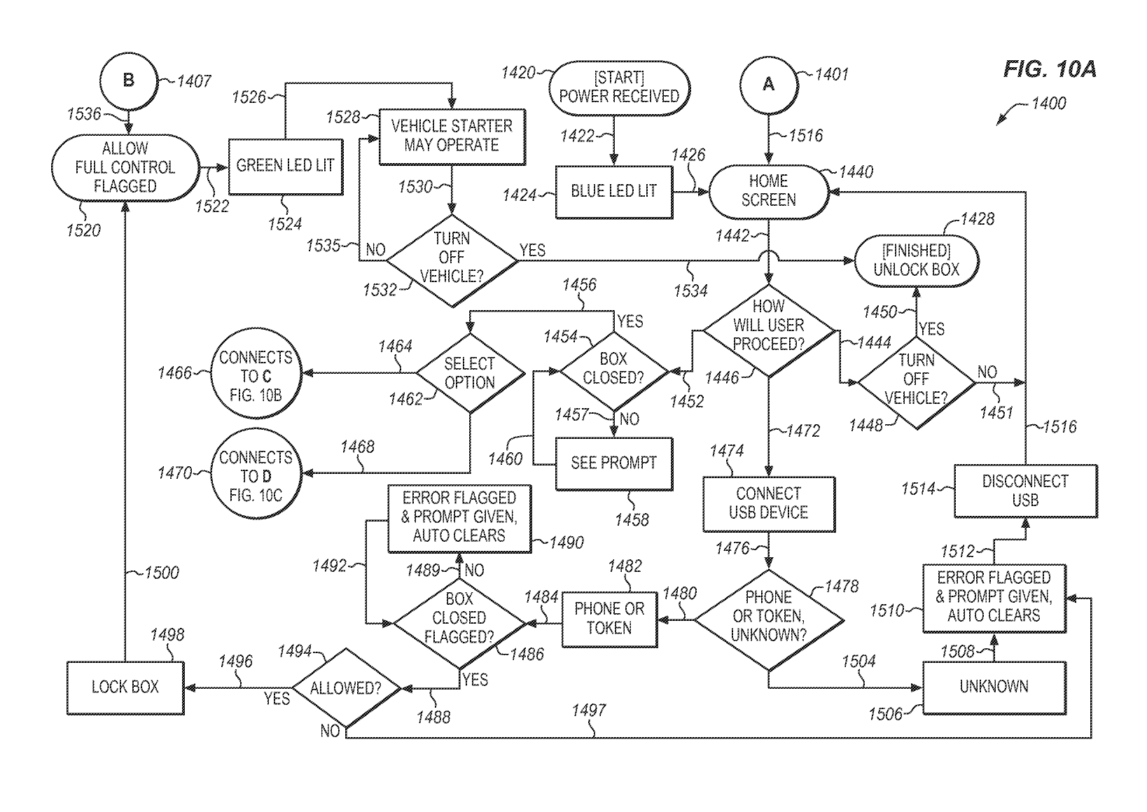

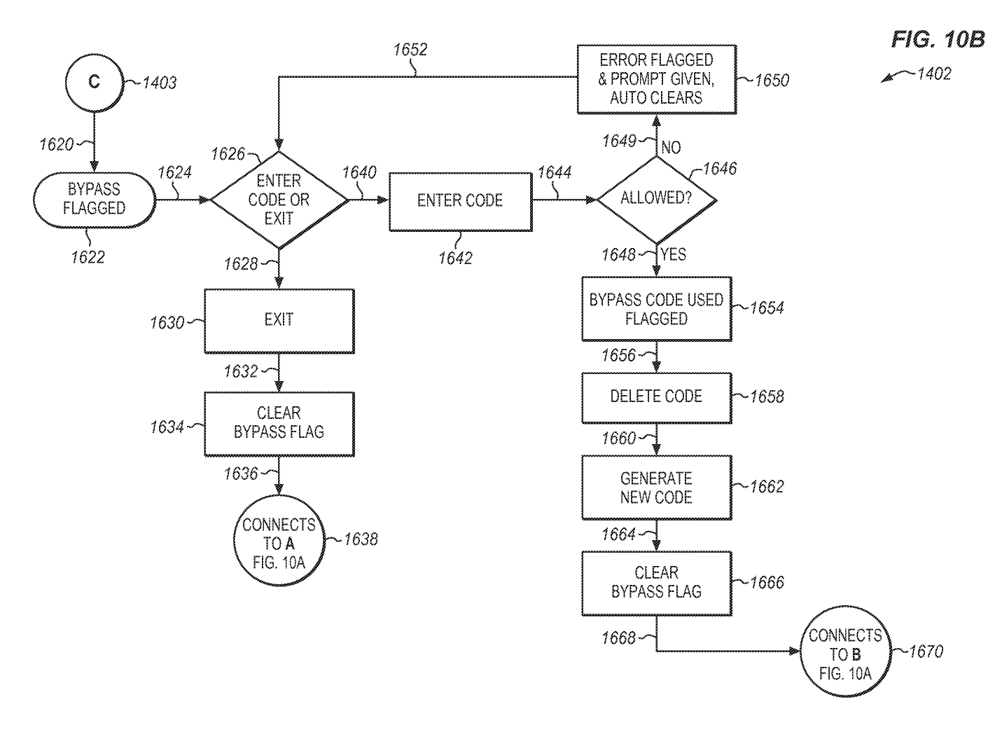

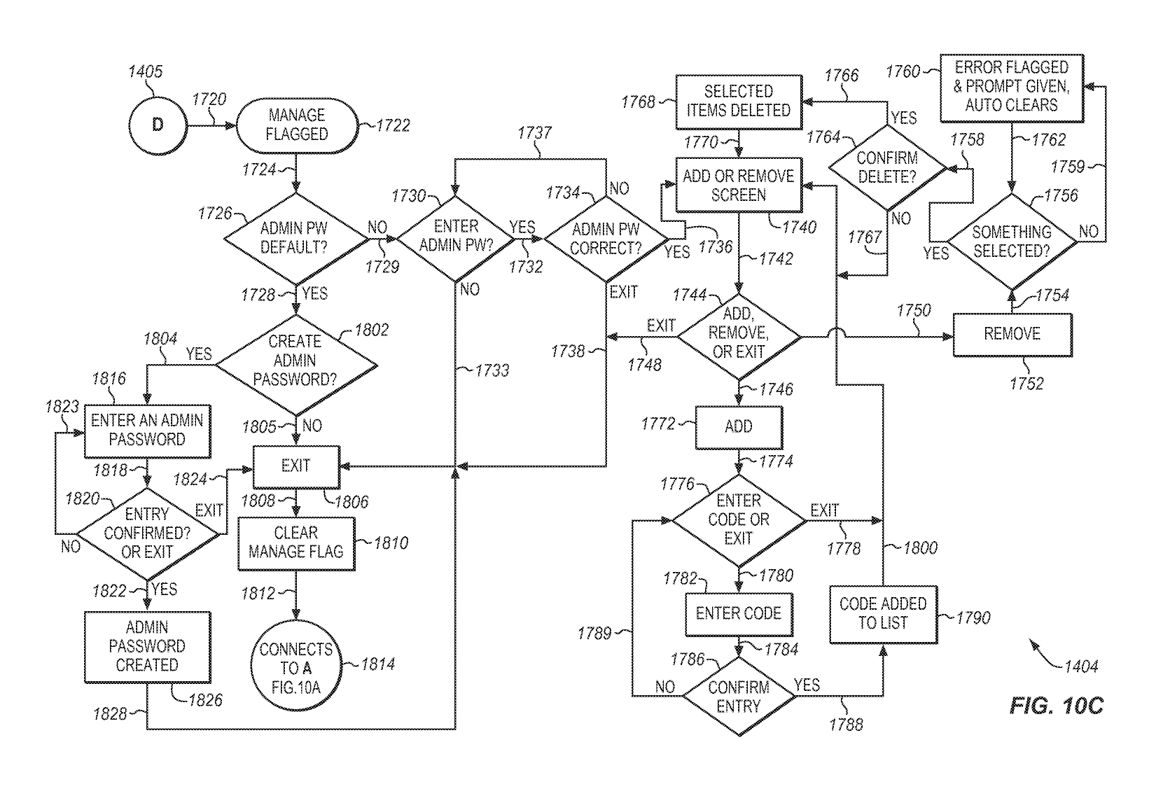

FIG. 10A is a diagram showing part of the arrangement of FIGS. 10A, 10B, and 10C which together illustrate an embodiment of a process for utilizing an add-on model of the safety systems illustrated above. FIG. 10A process 1400 contains one embodiment of an Allow Full Control function coupled together with one embodiment of a Home Screen function. Access to this figure from any other figure is made available by portal A 1401 or by portal D 1407. Process 1400 starts when the stops box receives power 1420. In this embodiment, a blue LED is lit to signal that power is being received 1424. The Home Screen function is now ready to operate. It will determine case 1434 (How will the user proceed?). The user has several options now: the user may close the stops box and select an option to manage the device or use a bypass code 1462, connect a USB device 1474, or turn off the vehicle ending the process 1448. If case 1478 (Phone or Token, Unknown?) is in condition 1504 unknown, the user is set on route 1504, 1506, 1508, 1510, 1512, 1514, and 1516, where the USB device was unknown 1506, an error flagged, and a prompt given that will auto clear 1510 (in which the user was asked to disconnect the USB device and try again), the USB was disconnected 1514, and the user returned to the home screen 1440. If case 1478 (Phone or Token, Unknown?) is in condition 1480 phone or token, the user must close the stops box 1488 for the allowed check 1494 to run. If the stops box is not closed, an error is flagged and a prompt given that will auto clear 1490. If the stops box was closed and the allowed check 1494 ran un-successfully 1497, an error is flagged and a prompt given that will auto clear 1510 (in which the user was asked to disconnect the USB device and try again), the USB was disconnected 1514, and the user returned to the home screen 1440. If the stops box was closed and the allowed check 1494 ran successfully 1496, the stops box will engage electronic lock 1498, locking the device inside. The user is set on route 1500 to gain full control at 1520 where allow full control is flagged. In this embodiment, a green LED is lit 1524 to indicate full control. The vehicle starter may now operate 1528 as long as the vehicle remains on. The device will remain locked in the box until the vehicle is turned off 1534. Once turned off, the process is ended and the stops box unlocked 1428. If the user chose to close the stops box and select an option 1462, the user could choose bypass 1464 or manage 1468. If the user chose the bypass option 1464, the user would be set on route 1466, 1403, 1620, and 1622, where the bypass is flagged 1622 and the bypass function started. If the user chose the manage option 1468, the user would be set on route 1470, 1405, 1720, and 1722, where manage is flagged 1722 and the manage function started. If the user chose to turn off the vehicle 1450, the program is ended and the stops box unlocked 1428.

FIG. 10B is a diagram showing part of the arrangement of FIGS. 10A, 10B, and 10C which together illustrate an embodiment of a process for utilizing an add-on model of the safety systems illustrated above. FIG. 10B process 1404 contains one embodiment of a Bypass function. Access to this figure from any other figure is made available by portal C 1403. Once any predetermined condition is met, allow full control becomes flagged 1622. In this embodiment, the function first checks to see if the user would like to continue 1626. If the user does not wish to continue condition 1628, the user is set on route 1628, 1630, 1632, 1634, 1636, 1638, 1401, 1516, and 1440. If the user chose to exit 1628, and did exit 1630, the bypass flagged was cleared 1634, and the user then was returned to the home screen 1440. If the user was to continue successfully through the bypass process, the user may take route 1640, 1642, 1644, 1646, 1648, 1654, 1656, 1658, 1660, 1662, 1664, 1666, 1668, 1670, 1407, 1536, and 1520. The user is requested to enter a code 1640, entered that code 1642, the code was checked against the allowed list 1646, the code was allowed 1648, bypass code used became flagged 1654, the used code was removed from the list 1658, a new code generated in its place 1662, the bypass flag cleared, and full control given to the user 1520. The user may fail to successfully use a bypass code by choosing to exit 1628 or by entering an invalid code 1649. If the user did enter an invalid code, an error is flagged and a prompt would be given that auto clears 1650. The user then is given the option to try again or exit 1626.

FIG. 10C is a diagram showing part of the arrangement of FIGS. 10A, 10B, and 10C which together illustrate an embodiment of a process for utilizing an add-on model of the safety systems illustrated above. FIG. 10C process 1404 contains one embodiment of a Manage function. Access to this figure from any other figure is made available by portal D 1405. Once any predetermined condition is met, manage becomes flagged 1722. Each time the user enters, the manage function first checks if admin password is still set at default 1726, possibly meaning the admin password has not been created or the stops box has been reset. If case 1826 (Admin Password Still Default) is in true condition 1728, the user will be given the option to create the admin password 1802. If the user was to successfully create an admin password, the user may take route 1802, 1804, 1816, 1818, 1820, 1822, and 1826. The user then may enter the password they would like to use 1816. The user will be shown what they had entered as a password and asked to confirm they want to use that entry 1820. If case 1820 (Entry Confirmed? or Exit) is in true condition 1822, the admin password is created 1826. The user then will be redirected to the home screen 1440 via route 1828, 1733, 1806, 1808, 1810, 1812, 1814, 1401, 1516, and 1440, where the manage function was exited 1706, manage flag cleared 1810, and the user connected back to FIG. 10A process 1400 via portal 1814. The ways the user may prolong or fail to successfully create an admin password are 1805, 1823, and 1824, where the user chose not to create admin password 1805, the user had not confirmed their entry 1823, or the user chose to exit instead of continuing 1824. If case 1726 (Admin Password Still Default) is in false condition 1729, the user already has created the admin password and now would be asked to enter the admin password 1730 or exit 1733. If the user chooses to continue with the admin process condition 1732 and enters the password, it then will be checked for accuracy 1734. If the password is incorrect condition 1737, the user may try again 1730 or exit 1733. If the password is correct condition 1736, the user will see the add or remove screen 1740. The user will have the options to add, remove, or exit 1744. If the user was to successfully add a code to the allowed list, the user may take route 1746, 1772, 1774, 1776, 1780, 1782, 1784, 1786, 1788, 1790, and 1800. The user enters a code 1776 and then is asked to confirm that entry 1786. The user then confirms that entry 1788, and the code is added to the allowed list 1790. The user then is taken back to the add or remove screen via path 1800. The ways the user may prolong or fail to successfully add a code to the allowed list are 1748, 1750, 1778, and 1789: the user chose to remove instead 1750, the user chose to exit the process 1748 or 1778, or the user was unable to confirm their entry 1789. If the user was to successfully remove a code from the allowed list, the user may take route 1750, 1752, 1754, 1756, 1758, 1764, 1766, 1768, 1770, and 1740. The user chooses that they want to remove something condition 1750. The user presses the remove option 1752 where the user had something on the list selected to remove condition 1758. The user then is asked to confirm this course of action 1764 and confirms it condition 1766. The selected items then are deleted by the user's request 1768. The user then is returned back to the add or remove screen 1740. The ways the user may prolong or fail to successfully remove a code from the allowed list are 1746, 1748, 1759, and 1767: the user chose to exit 1748, the user did not have anything selected to delete 1759 (in which an error was flagged and a prompt given that will auto clear under a predetermined condition 1760. In one embodiment, the condition could be that something has be selected), or the user decided not to confirm the delete process 1767.

The system may also include other features that, now that the details above have been described, can be understood by one skilled in the art. For example, the system may allow list management, including registration on the list and a doorkeeper function allowing only registered persons to operate the system. It may also include a password function, allowing change password functions. It may include a phone registration function, allowing phones to be added, removed or reset, that is, the entire list removed.

It should be understood that the processes described above are only a few of the processes that may be utilized in connection with the stops box. Now that the stops box system has been described and examples of how it operates have been provided, those skilled in the art may devise many other useful processes in which the stops box may be utilized.

The stops box 110 compartment, such as 214, may be either built in or added and may be electrically connected into the ignition system or onboard computer of a vehicle to prevent the physical and/or visual use of a cell phone to the driver while driving. This would effectively take the phone out of the hands of the driver for the duration of the trip. The phone would still be useable with Bluetooth devices. However it will not allow the vehicle to start/operate fully without the phone being sealed in the safety device. The box may have a USB port that would allow the phone to charge and an auxiliary port to allow music to play in a vehicle.

The stops box may be able to allow a number of programmed drivers/users. There may be a form of registration that gives phones a unique identification. A single phone may be registered to several safety boxes if the owner has more than one vehicle. This registered user system may represent an added anti-theft protection for the vehicle.

In one embodiment, there may be a physical means of registration, such as some form of detectable sticker 556. In one embodiment, it would be placed under the battery of the phone. In one embodiment, there may be a process in which an administrator entered a code or password to register a new device. A sticker then may be added to the phone and the phone placed in the box. The box then may read the sticker and register it to the user. The sticker may be made tamperproof. For example, if removal was attempted, the sticker would be destroyed. This would prevent unwanted authorization.

Registration may also be done by a software application. While software easily can be disabled, a person registering a phone has no incentive to disable the software.

The system 100, 200, 300, 400 may also be provided with one or more tokens that may be used to rapidly register a cell phone.

A feature of the embodiments described is that they may become as important a safety feature as adding seat belts or airbags to vehicles. This safety device could save the lives or prevent severe injuries of untold numbers of people in the years to come. For example, the device may become a standard in all or most vehicles. Built-in units may more easily have more functionality, for example, tell when the vehicle was in park and, therefore, allow physical access to the phone. Functionality built in the vehicle could bypass Bluetooth. For example, it may be possible to talk directly to the vehicle to give the phone commands and hear it through speakers.

There is a potentially large market for the stops box, i.e., any vehicle in any country in the world where drivers have phones, particularly since the design is relatively simple and easy to produce at a low cost as compared to its importance. The vehicle may be an automobile, such as a car or truck, a tractor, a boat, a motorcycle, a snowmobile, an airplane or any other vehicle. The device may be used to enforce hands-free laws and anti-texting laws. A person caught texting while driving may be required to install this device in his or her vehicle. This is similar to the breathalyzer systems given to those people who receive a DUI violation. They must pass a breath test before the device will let them start their vehicle. The system described herein provides an alternative to fines and imprisonment for wrongful use of cell phones. Companies that manufacture cell phones and the mobile carrier companies will have an incentive to implement the system in their products, as it will create a positive image and will incentivize the parents that buy the cell phones for their children to purchase one from the company. Companies that produce the vehicles also will enhance their image by providing the devices in their manufactured vehicles, and failure to provide an available safety device could be seen as creating liability. Insurance companies may see the described system as a method of reducing costs of insuring vehicles and may be inclined to reduce insurance rates for vehicles with the system installed.

A feature of the embodiments described herein is that passengers are able to use their own cell phones while in the car in contrast to jamming systems which jam all cell phones in a vehicle and may even jam phones in a neighboring vehicle. In one embodiment, temporary use codes or one-time use codes maybe gained from a Help desk like On-Star™. In one embodiment, there is an ability to interface with the phone through voice to gain access to greater functionality of the phone without physical or visual contact.

The embodiments described herein provide a safety device that eliminates cell phones as a visual or physical distraction to drivers. They also provide a system and method that hinders the vehicle's ability to operate if the phone was not being used properly. The embodiments herein have the controlled ability to register multiple phone devices to the stops box or multiple stops boxes to a phone device.

It is a feature of one or more embodiments described herein that they are disruptive of the practice of using cell phones in a distracting manner while driving. Many, if not all, prior art devices meant to reduce distractions due to cell phone use have stopped short of being disruptive, perhaps due to a latent concern that certain persons would not accept a disruptive system. However, this essentially has proved counterproductive to the goal of preventing distracted driving due to the presence of cellphones. However, at the same time, the system described herein does not prevent non-distracting use of cell phones, such as hands-free operation.

The present disclosure describes apparatus 100, 200, 300, 400 to prevent distracted driving of a vehicle due to use of a cell phone, such as 250, 500, the apparatus comprising: cell phone holder 214, 322, adapted to hold a cell phone 250, 500 in a position such that its keyboard 252, 517 cannot be accessed; a registration system 303 for registering a cell phone with the apparatus; a short range detector 220 for detecting whether or not the registered cell phone is located in the cell phone holder; and a vehicle enabling/disabling circuit 304, responsive to the short range detector, for preventing the vehicle from being operated if the registered cell phone is not located in the cell phone holder and for enabling operation of the vehicle if the registered cell phone is in the cell phone holder. The cell phone holder 214 may comprise a lockable enclosure 214, 620 for enclosing the cell phone. Alternatively, the cell phone holder may comprise a sleeve 622 for slidably receiving the cell phone. The short range detector may comprise a near-field communication (NFC) device 475. Alternatively, the short range detector may comprise a bar code reader. In another embodiment, the short range detector may comprise a sticker. In a further embodiment, the short range detector may comprise an NFC tag. In a further embodiment, the short range detector may comprise a USB port 645. In a further embodiment, the apparatus may further include a token 422 which mimics the registered phone. In one embodiment, the token may comprise a USB memory stick 422. In one embodiment, the vehicle may include a starter 160, 306, and the vehicle enabling/disabling circuit may comprise a system 304 for preventing operation of the starter. In another embodiment, the cell phone holder may include a lock 226, 650 for preventing access to the cell phone. In one embodiment, the lock includes a servo motor 374 for engaging the lock. In one embodiment, the apparatus may further comprise a vehicle range detector to determine if a registered cell phone is in the vehicle but not in the holder.

In another aspect, there is a method of preventing distracted driving of a vehicle due to use of a cell phone, the method comprising: providing a cell phone holder 214, 620 for preventing physical access to at least a portion of the controls 252 of a cell phone; and preventing operation of the vehicle unless the cell phone is in the cell phone holder and the physical access is prevented. In one embodiment, the vehicle includes a vehicle battery 140, 314 and a vehicle starting system, and the preventing comprises opening an electrical circuit 304 between the battery and at least a portion of the vehicle starting system. In another embodiment, the method further comprises associating a unique identification with a cell phone, and the preventing comprises identifying the cell phone having a unique identification. In a further embodiment, the cell phone includes an electronic memory 366, and the associating comprises storing electronic identification information in the electronic memory. In one embodiment, the associating comprises placing a sticker on the cell phone. In one embodiment, the cell phone includes a key pad, and the preventing comprises preventing access to the key pad.

This disclosure also describes a system comprising a vehicle control system 304 for preventing operation of a vehicle unless a cell phone having a unique identification is physically inaccessible.

There have been described novel methods, systems, and devices that prevent distracted driving due to cell phone use. Now that embodiments have been described, those skilled in the art will be able to adapt them to other methods systems, and devices. It will also be evident to those skilled in the art that the various parts of the embodiments may be combined in many different ways. It should be understood that each of the processes and apparatus described can be combined with any of the other processes and apparatus. After review of this disclosure, additional advantages and modifications will readily appear to those skilled in the art.

What is claimed is:

1. An apparatus to prevent distracted driving of a vehicle due to use of a cell phone, said apparatus comprising:
a cell phone holder adapted to hold a cell phone in a position such that its keyboard cannot be accessed;
a registration system for registering a cell phone with said apparatus;
a short range detector for detecting whether or not said registered cell phone is located in said cell phone holder; and
a vehicle enabling/disabling circuit, responsive to said short range detector, for preventing said vehicle from being operated if said registered cell phone is not located in said cell phone holder and for enabling operation of said vehicle if said registered cell phone is in said cell phone holder.

2. An apparatus as in claim 1 wherein said cell phone holder comprises a lockable enclosure for enclosing said cell phone.

3. An apparatus as in claim 1 wherein said cell phone holder comprises a sleeve for slidably receiving said cell phone.

4. An apparatus as in claim 1 wherein said short range detector comprises a near-field communication (NFC) device.

5. An apparatus as in claim 1 wherein said short range detector comprises a bar code reader.

6. An apparatus as in claim 1 wherein said short range detector comprises a sticker.

7. An apparatus as in claim 1 wherein said short range detector comprises an NFC tag.

8. An apparatus as in claim 1 wherein said short range detector comprises a USB port.

9. An apparatus as in claim 1, and further comprising a token which mimics said registered phone.

10. An apparatus as in claim 9 wherein said token comprises a USB memory stick.

11. An apparatus as in claim 1 wherein said vehicle includes a starter, and said vehicle enabling/disabling circuit comprises a system for preventing operation of said starter.

12. An apparatus as in claim 1 wherein said cell phone holder includes a lock for preventing access to said cell phone.

13. An apparatus as in claim 12 wherein said lock includes a servo motor for engaging said lock.

14. An apparatus as in claim 1, and further comprising a vehicle range detector to determine if a registered cell phone is in said vehicle but not in said holder.

15. A method of preventing distracted driving of a vehicle due to use of a cell phone, said method comprising:
providing a cell phone holder for preventing physical access to at least a portion of the controls of a cell phone; and
preventing operation of said vehicle unless said cell phone is in said cell phone holder and said physical access is prevented.

16. A method as in claim 15 wherein said vehicle includes a vehicle battery and a vehicle starting system, and said preventing comprises opening an electrical circuit between said battery and at least a portion of said vehicle starting system.

17. A method as in claim 15, and further comprising associating a unique identification with a cell phone, and said preventing comprises identifying said cell phone having a unique identification.

18. A method as in claim 17 wherein said cell phone includes an electronic memory, and said associating comprises storing electronic identification information in said electronic memory.

19. A method as in claim 17 wherein said associating comprises placing a sticker on said cell phone.

20. A method as in claim 15 wherein said cell phone includes a key pad, and said preventing comprises non-access to said key pad.

21. A system comprising:
a vehicle control system for preventing operation of a vehicle unless a cell phone having a unique identification is physically inaccessible; and
a cell phone having said unique identification.
